(19) United States
(12) Patent Application Publication
(10) Pub. No.: US 2025/0005836 A1
(43) Pub. Date: Jan. 2, 2025

(54) DYNAMIC REAL TIME AVATAR-BASED AI COMMUNICATION SYSTEM

(71) Applicant: Sagen AI Corp., Middletown, DE (US)

(72) Inventors: Viva Chu, Old Greenwich, CT (US); Shane Holland, Mission Viejo, CA (US)

(21) Appl. No.: 18/758,412

(22) Filed: Jun. 28, 2024

Related U.S. Application Data
(60) Provisional application No. 63/524,466, filed on Jun. 30, 2023.

(51) Int. Cl. G06T 13/40; G06F 21/10; G06F 40/35; G06T 13/20

(52) U.S. Cl. CPC G06T 13/40; G06F 21/1014; G06F 21/107; G06T 13/205; G06F 40/35; G06T 2200/24

(57) ABSTRACT

A novel avatar-based conversational AI platform that integrates large language models (LLMs) with realistic avatar visualization is disclosed. The platform employs advanced AI technologies to create lifelike avatars capable of personalized and emotionally responsive communication with users. avatar creation tools enable users to generate unique avatar configurations, while animation machine learning subsystems automatically generate the avatar's speech, movements, and emotional responses in real-time. personality machine learning subsystems direct the avatar's voice, personality, and emotions, enhancing the realism of the interaction. The platform supports integration with third-party applications and provides comprehensive deployment and asset management tools. A two-way messaging architecture enables real-time interactions between avatars and users. Authorization and licensing controls protect intellectual property rights, while the avatar's personality dynamically evolves based on user interactions. By integrating LLMs, real-time animation, and emotional intelligence, the platform offers a groundbreaking solution for creating immersive and personalized conversational experiences across various applications.

### CROSS-REFERENCE TO RELATED APPLICATIONS

Priority is claimed in the application data sheet to the following patents or patent applications, each of which is expressly incorporated herein by reference in its entirety: 63/524,466

### BACKGROUND OF THE INVENTION

### Field of the Art

The present invention relates to the field of conversational AI and interactive computer graphics, particularly in the context of creating engaging and realistic avatar-based experiences powered by large language models and blockchain technology.

### Discussion of the State of the Art

Conversational AI has emerged as a transformative technology, enabling natural and intuitive interactions between humans and machines. Recent advancements in large language models (LLMs), such as GPT-3, have revolutionized the field by generating human-like responses and engaging in context-aware conversations. However, the current state of the art primarily focuses on text-based or voice-based interactions, lacking the visual and emotional dimensions that are crucial for creating truly immersive and lifelike conversational experiences.

Realistic avatar generation and animation have made significant strides in recent years, with techniques like 3D modeling, motion capture, and real-time rendering enabling the creation of visually compelling characters. However, integrating these animated avatars with conversational AI systems remains a challenge, as it requires seamless synchronization between the avatar's visual appearance, lip movements, and the generated speech output. Existing approaches often rely on pre-recorded or manually animated avatar responses, limiting the dynamism and adaptability of the conversational experience.

Attempts have been made to combine conversational AI with animated avatars to enhance user engagement and create more lifelike interactions. For example, the work by Lee et al. (2021) proposed a system that generates lip-sync animations based on phoneme-level alignment of the speech output. Another approach by Kim et al. (2022) utilized deep learning techniques to generate realistic facial expressions and gestures for avatars based on the conversation context. While these methods improve the visual aspects of avatar-based conversations, they often lack the real-time responsiveness and natural language understanding capabilities provided by state-of-the-art LLMs.

The current state of the art lacks a comprehensive solution that seamlessly integrates advanced conversational AI, powered by LLMs, with realistic avatar visualization and animation. Existing approaches either prioritize the conversational aspect while neglecting the visual realism or focus on avatar generation without leveraging the full potential of LLMs for natural language interaction. Moreover, the management and tracking of avatar instances, usage rights, and intellectual property in a secure and decentralized manner remain unaddressed.

Therefore, there is a need for a novel approach that combines the power of LLMs with realistic avatar visualization, enabling highly engaging and interactive conversational experiences. The proposed avatar-based conversational AI platform addresses this need by integrating GPT-3-like models with advanced avatar customization, automated lip-sync animation, and real-time rendering. By leveraging blockchain technology for avatar instance management and usage tracking, the platform ensures secure and transparent control over intellectual property rights.

The proposed invention advances the state of the art by providing a comprehensive solution that brings together cutting-edge conversational AI, realistic avatar visualization, and blockchain-based management. This holistic approach opens new possibilities for creating immersive and personalized conversational experiences in various domains, such as virtual assistants, gaming, education, and entertainment, while ensuring the protection of intellectual property and enabling new business models in the era of conversational AI.

### SUMMARY OF THE INVENTION

Accordingly, the inventor has conceived and reduced to practice a system and method for integrating large language models (LLMs) to generate human-like conversational responses with a stylized or realistic unique generated avatar (UGA) visualization that is capable of lip-sync animation, facial expressions, and body gestures. The system comprises system integration layers, data processing routines, and machine learning subsystems working independently and in concert to generate a unique and personalized user experience. The invention leverages state-of-the-art LLMs, including but not limited to GPT-3, to enable UGAs to engage in contextually relevant and coherent conversations. The LLMs are trained in domain specific knowledge-such as healthcare, education, and entertainment-allowing the UGAs to provide expert-level guidance and information over a variety of fields. The invention incorporates advanced natural language processing techniques such as sentiment analysis and named entity recognition, to determine the appropriate emotional responses and facial responses for UGAs.

In an embodiment avatar creation tools are present, which comprises a set of software tools to upload, configure, and manage a combination of photographs, videos, and audio clips to train and work in conjunction with various machine learning subsystems to generate a fully unique and customized avatar.

In an embodiment, an asset generation subsystem is present consisting of a machine learning core trained to produce the physical appearance of a UGA from input data such as images and video.

In an embodiment, an animation machine learning subsystem is present in which system integration layers, data processing routines, and machine learning subsystems work independently and in concert to automatically generate and/or direct the visualization of speech, body movements, gestures, and emotional response of a UGA as it relates to the context of a request or conversation with an LLM.

In an embodiment, a personality machine learning subsystem is present in which system integration layers, data processing routines, and machine learning subsystems work independently and in concert to automatically generate and/or direct the tone, speed, and volume of a UGA's voice and the visualization of a unique personality trait or combination of personality traits of a UGA character as it relates to the context of a request or conversation with an LLM.

In an embodiment, distinct phonetic voice patterns in an audio stream are mapped using system integration layers, data processing routines, and machine learning subsystems working independently and in concert to one or more viseme mouth shapes and facial poses synchronized in real-time against the timeline of the original audio.

In an embodiment, the system is configured to automatically generate and/or direct the visualization and voice representations of the emotions and feelings of an UGA character as it relates to the context of a request or conversation with an LLM.

In an embodiment, the system is configured to automatically generate and/or direct the visualization and voice representations of the emotions and feelings of UGA as it relates to the perceived emotional state of the real-life users or other AI generated characters with which it is interacting.

In an embodiment, text to speech and speech to text processes are present and incorporated as needed to facilitate natural voice conversation with the UGA.

In an embodiment, the system is configured to automatically generate LLM prompts that reflect the unique personality traits and emotional sensitivities of a UGA instance.

In an embodiment, the system is configured to automatically generate and/or direct an UGA's interaction with the windows, data structures, popups, text fields, data structures, and other UI elements and algorithms of a third-party software application which has integrated the claimed invention in its codebase.

In an embodiment, a set of software tools is present and configured to interact with the system to manage the discrete deployment of art assets, audio, and code files that represent a UGA configuration.

In an embodiment, a set of software tools is present and configured to interact with the system to track, analyze, and display the usage of a UGA configuration and each of its discrete components in a live deployment environment.

In an embodiment, a set of software tools is present and configured to interact with the system to authorize the hosting and use of a UGA configuration and each of its discrete components in a live deployment environment.

In an embodiment, a message-based architecture is present to support real-time dynamic push and pull communications between individual and groups of UGA instances.

### BRIEF DESCRIPTION OF THE DRAWING FIGURES

FIG. 1 is a diagram depicting the architecture of the avatar creation tool.

FIG. 2 is a diagram depicting the architecture of the asset generation subsystem.

FIG. 3 is a diagram depicting the architecture of the animation subsystem.

FIG. 4 is a diagram depicting the architecture of the personality subsystem.

FIG. 5 is a diagram depicting the architecture of the audio to viseme subsystem.

FIG. 6 is a method flowchart depicting the steps for a user to create a unique generated avatar.

FIG. 7 is a method flowchart depicting the steps real-time user interaction with a unique generated avatar instance.

FIG. 8 is a method flowchart depicting the steps for third-party UI integration

FIG. 9 is a method flowchart for asset management.

FIG. 10 illustrates an exemplary computing environment on which an embodiment described herein may be implemented, in full or in part.

### DETAILED DESCRIPTION OF THE INVENTION

The inventor has conceived and reduced to practice a system and method for integrating large language models (LLMs) with stylized or realistic unique generated avatar (UGA) visualizations capable of lip-sync animation, facial expressions, and body gestures. This system comprises an avatar creation tool, which allows users to upload photographs, videos, and audio clips to generate fully customized avatars. The tool employs machine learning subsystems to process input data and create unique avatar configurations, including physical appearance, voice, personality traits, and emotional settings.

The system incorporates an asset generation subsystem that utilizes machine learning to produce the physical appearance of a UGA from input data. An animation subsystem automatically generates and directs the visualization of speech, body movements, gestures, and emotional responses of a UGA in real-time, based on the context of conversations with an LLM. Additionally, a personality subsystem employs machine learning to automatically generate and direct the tone, speed, and volume of a UGA's voice, as well as the visualization of unique personality traits. Text to Speech and Speech to Text capabilities are integrated with the subsystems to facilitate natural conversation with a UGA.

A key feature of the invention is its audio to viseme subsystem, which maps distinct phonetic voice patterns in an audio stream to viseme mouth shapes and facial poses. This mapping is synchronized in real-time against the timeline of the original audio, enabling highly realistic lip-sync animation. The system also includes emotional intelligence capabilities, allowing the UGA to recognize and respond to the perceived emotional state of users or other AI-generated characters it interacts with.

The invention provides integration methods for UGA instances to interact with underlying UI components, data structures, and API calls of third-party applications. This enables the UGA to direct the user experience within various software environments. The system also includes a two-way messaging architecture that supports real-time dynamic push and pull communications between individual and groups of UGA instances, as well as human users. Furthermore, the invention incorporates a comprehensive set of tools for UGA

deployment, asset management, and usage tracking. These tools enable the discrete deployment of art assets, audio, and code files representing UGA configurations, as well as analytics on UGA performance and user interactions. The system also includes authorization and licensing controls to protect intellectual property rights and manage the distribution of UGA instances. By combining cutting-edge conversational AI, realistic avatar visualization, and blockchain-based management, this invention opens new possibilities for creating immersive and personalized conversational experiences across various domains.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “character rigging files” refers to a set of data and instructions used in 3D animation software to define the structure, movement, and deformation of a digital character model.

The term “phoneme” refers to A phoneme is the smallest unit of sound in a language that distinguishes one word from another. For example, in English, the words “bat” and “pat” are distinguished by the phonemes/b/and/p/.

The term “viseme” refers to a visual representation of a phoneme, which is the basic unit of sound in a language. Visemes are the mouth shapes and facial movements that correspond to specific phonemes when speaking. In animation, visemes are used to create realistic lip-syncing and facial expressions for characters.

The term “inverse kinetics” refers to a mathematical technique used in computer animation and robotics to calculate the joint angles needed to place an end effector (like a hand or foot) at a desired position in 3D space. It works backwards from the desired position of the end effector to determine the necessary configuration of the connected joints, allowing for more natural and efficient animation of complex movements in characters or control of robotic limbs.

The term “Application Programming Interface (API)” refers to set of protocols, routines, and tools for building software applications that specifies how software components should interact.

The term “machine learning subsystem” refers to a component of an AI system that uses algorithms and statistical models to improve its performance on a specific task through experience, without being explicitly programmed.

### Avatar Character Creation Tool

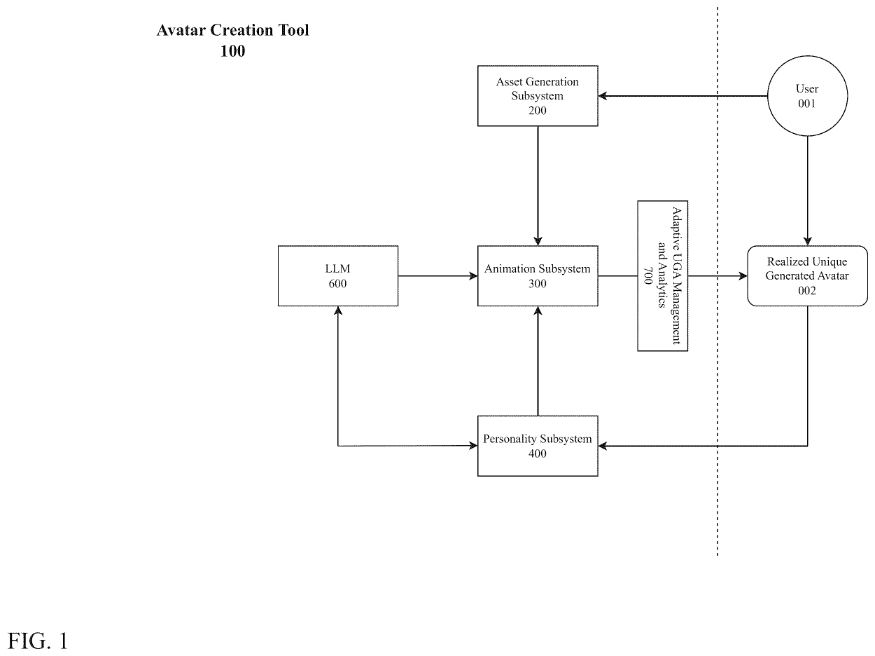

FIG. 1 is a diagram depicting the architecture of the Avatar Character Creation Tool 100, a platform which allows a user 101 to generate a unique generated avatar (UGA) 102 instance.

The Avatar Character Creation Tool comprises a set of software tools to upload, configure, and manage a combination of photographs, videos, and audio clips. These tools work in conjunction with various machine learning subsystems such as asset generation 200, animation 300, personality 400, and a large language model (LLM) 600 such as ChatGPT to generate a fully unique and customized avatar.

In an embodiment, the LLM 600 has access to a customer vector database. A customer vector database is a specialized database that stores customer data in the form of high-dimensional vectors. These vectors are numerical representations of customer attributes, behaviors, preferences, and interactions. Each customer is represented by a unique vector in this high-dimensional space.

In another embodiment, the LLM 600 has access to and has been trained on specialized information and processes such as healthcare or a country's legal system to provide users with expert-level guidance and information in specific domains. This specialized training allows the LLM to offer accurate, context-aware responses in fields such as medicine, potentially enabling the UGA to serve as a virtual healthcare assistant or medical information resource.

In another embodiment, adaptive UGA management and analytics 700 are applied to the UGA instance. This system dynamically manages files representing UGA configurations alongside comprehensive data analytics on UGA performance and user interactions. This integrated approach enables real-time optimization and in-depth analysis of user engagement patterns, UGA effectiveness, and system performance metrics. The analytics component processes large volumes of interaction data, employing advanced statistical methods and machine learning algorithms to extract meaningful insights and drive continuous improvements.

Additionally, the system incorporates robust authorization and licensing controls to protect intellectual property rights and manage the distribution of UGA instances. These controls govern access to UGA configurations, regulate usage based on licensing terms, and ensure compliance with data privacy regulations, all while allowing for the adaptive evolution of UGA instances based on analytical insights.

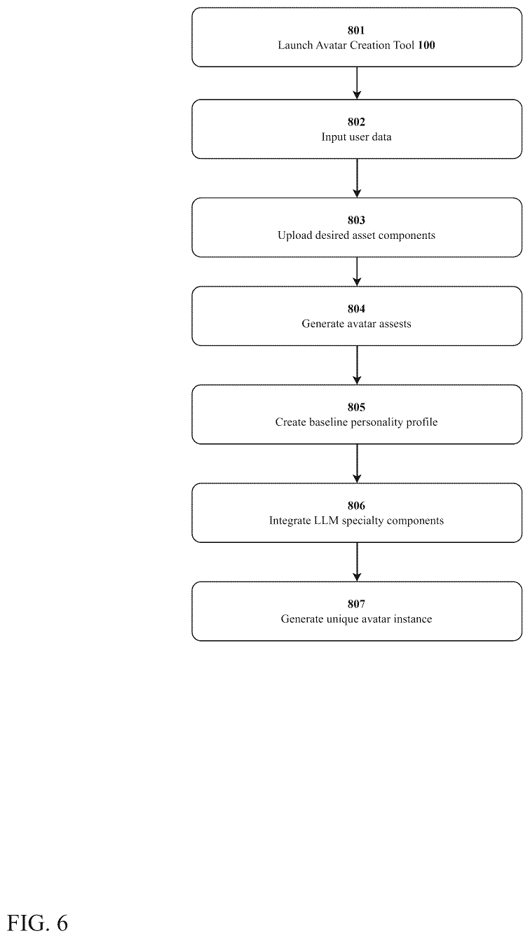

FIG. 6 is a method flowchart depicting the steps for a user to create a unique generated avatar. Once the avatar creation tool 100 software is launched 801, user data is input to the system 802. User data may include but is not limited to avatar appearance and/or personality preferences, third-party integration data, interaction history data, learning progress (in an educational use case), or analytics. The user then may upload desired asset components for the instance's avatar 803. The avatar assets are generated 804, as is the baseline personality profile of the avatar 805. Specialization components from a trained LLM are then integrated into the avatar instance 806. The unique avatar instance is then generated for the user 807, and the use session begins.

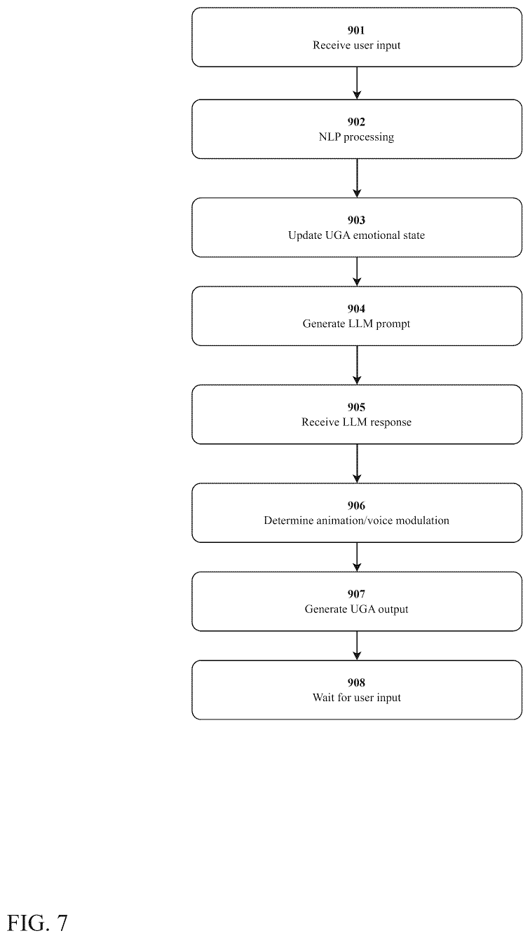

FIG. 7 is a method flowchart depicting the steps real-time user interaction with a unique generated avatar instance. The system first receives input from the user 901 which could be in the form of text, speech, or non-verbal cues such as facial expressions or gestures. The input undergoes natural language processing 902 to parse the text, understand intent, and extract key information from the input. The personality subsystem 400 processes the input to update the UGA's emotional state 903, adjusting values across multiple emotional dimensions using probabilistic state estimation. Based on the input context and the UGA's updated personality and/or emotional state, the system generates a prompt for the LLM 904. The LLM processes the prompt and generates a response 905 which is both contextually relevant and aligned with the UGA instance's emotive state. The system processes the LLM response to determine appropriate animations and voice modulations 906, then generates the UGA's output 907. The output may include advice, information, or assistance depending on the use case of the UGA instance and its third-party integrations. The system then returns to a state where it's ready to receive the next input from the user 908, maintaining the context from previous interactions and iterations.

### Asset Generation Subsystem

The asset generation subsystem is responsible for creating the foundational structure of the UGA including its 3D model, skeletal rig, facial rig, textures, and animation controls. This subsystem processes input data such as images, video, and audio to generate fully realized avatar model rigging.

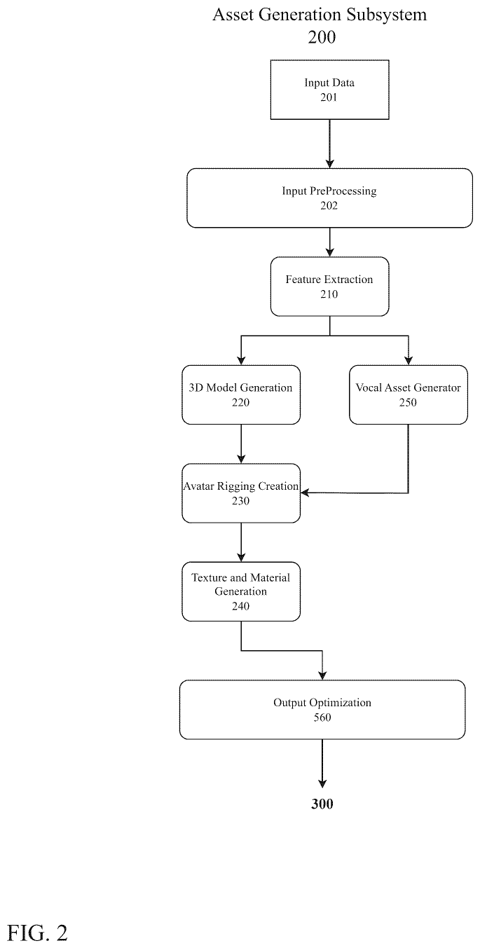

FIG. 2 is a diagram depicting the architecture of the asset generation subsystem 200. The asset generation subsystem is a machine learning core designed to produce the physical appearance and structure of a UGA from various input data types including images, audio, and video. This subsystem employs a multi-step process to create a fully realized avatar rigging, leveraging advanced AI techniques to interpret and transform the input data into a cohesive 3D character model.

Input data 201 is received in the form of audio, image, or video data. The process begins with input data preprocessing 202; for images, the system uses computer vision techniques to analyze 2D pictures, detecting facial features, body proportions, and distinctive characteristics. When processing video input, the subsystem employs frame-by-frame analysis and motion tracking to capture dynamic aspects of appearance and movement. Audio input is analyzed using voice analysis algorithms to extract vocal characteristics that could inform the avatar's speech patterns and potentially influence facial features.

Following data processing, the system moves on to feature extraction 210. Convolutional Neural Networks (CNNs) are utilized to extract high-level features from visual data. For audio input, spectral analysis and speech recognition techniques are employed to identify unique voice qualities.

Using the extracted features, the asset generation subsystem then generates a 3D model 220 of the avatar. Techniques such as photogrammetry for image-based 3D reconstruction or Adversarial Networks (GANs) to create high-fidelity 3D models that closely match the input data are employed. The generated 3D model serves as the base upon which the avatar rigging structure 230 is built.

Based on the generated 3D model, the system creates a skeletal structure (rig) for the avatar 230. This involves defining a hierarchy of bones and joints that will control the avatar's movements. The rigging process might use machine learning models trained on motion capture data to predict optimal joint placements and bone structures. Once the skeletal structure is in place, the system applies skin weights to the 3D model, determining how each vertex of the model's mesh is influenced by the underlying skeletal structure. For detailed facial animations, the asset generation subsystem creates a facial rig with blend shapes or a muscle system. This process involves identifying key facial landmarks from the input data and mapping them to predefined facial expression templates. The system then generates a set of animation controls (often called a rig interface) that allows for easy manipulation of the avatar. These controls might be customized based on the specific features and capabilities identified in the input data.

Using the input images and video, the system creates textures and materials 240 for the avatar's skin, hair, and clothing. AI-powered texture synthesis techniques are employed to generate high-resolution textures that match the input data.

If audio input is provided, the subsystem creates a voice model for the avatar in the vocal asset generator 550, capturing unique aspects of the voice such as pitch, timbre, and speech patterns. This voice model is integrated with the facial rig to enable realistic lip-syncing.

In an embodiment, third party vocal asset generators are incorporated into the system.

The final step involves optimizing the avatar rigging 560 for real-time performance. This includes creating different levels of detail for various use cases, compressing textures, simplifying the rig for mobile devices, or creating scalable versions of the avatar for different computational capacities. The result is a complete, animatable 3D character model that captures the essence of the input data while being optimized for real-time interaction within the larger UGA system.

Throughout this process, the asset generation subsystem is designed to interface seamlessly with other components of the UGA system, particularly the Animation Subsystem and the audio to viseme subsystem. It provides the necessary hooks and controls for real-time animation and lip-syncing, ensuring that the generated avatar can be brought to life in a realistic and engaging manner.

The resulting avatar rigging is designed to interface seamlessly with other components of the UGA system, particularly the animation subsystem and the audio to viseme subsystem. It provides the necessary hooks and controls for real-time animation and lip syncing, ensuring the UGA is brought to life in a realistic and engaging manner.

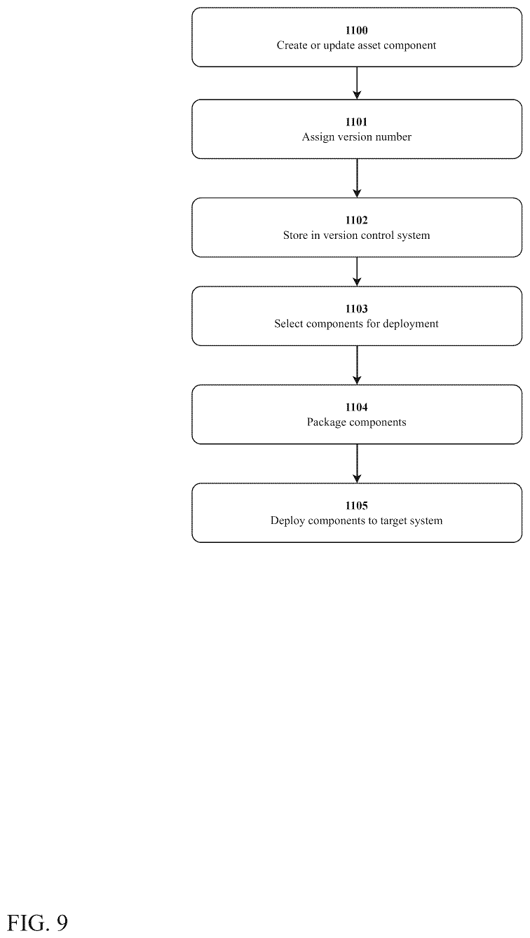

FIG. 9 is a method flowchart for asset management. The process begins with the need to create a new UGA component or update an existing one 1100. This could be prompted by various factors such as new feature developments, bug fixes, or improvements based on user feedback and/or analytics. The component, including but not limited to art assets, textures, or code files which control the UGA's behavior, is then created or updated 1101. Each component is given a unique version identifier 1102 to assist in tracking changes, managing different iterations of components, and/or ensuring compatibility between different parts of the UGA system. The newly updated or created component is then stored in version control system 1103. This could be a standard software version control system such as Git. Components are then chosen for deployment 1104 to a UGA instance, guided by user requests or automated based on predefined rules of compatibility requirements. The selected components are bundled together into a deployable package 1105. This packaging process may involve optimizations such as compressing assets, creation different versions for various platforms, or adjusting for system capabilities. The packaged UGA configuration is then deployed to the intended environment 1106.

### Animation and Viseme Subsystems

Commercially available animation design software such as Autodesk Maya, Live2D, or Blender allows animators to import character artwork and create character rigs from which they then use various animation techniques, such as keyframe animation, timeline-based animation, or skeletal animation, to bring the characters to life. Animators set key poses and interpolate movements between them to create smooth animations. The final animations can be exported in various formats for playback or integration into larger projects or Game Development Environments and Game Engines such as Unity or Unreal.

These exported files generated from existing third party animation software systems are collectively referred to as character rigging files and typically include the following: art asset images and texture files for each individual body part or component of a character or sprite, character definitions which reference groupings and placements of each art asset on a layer or stage, and animation sequences where sprites are mapped to timelines and movements through a 2D or 3D coordinate space.

The animation subsystem is a sophisticated component of the UGA system, designed to bring the avatar to life through realistic speech and movement. This subsystem operates in real-time, taking inputs from various sources to create a cohesive and engaging animated performance for the avatar.

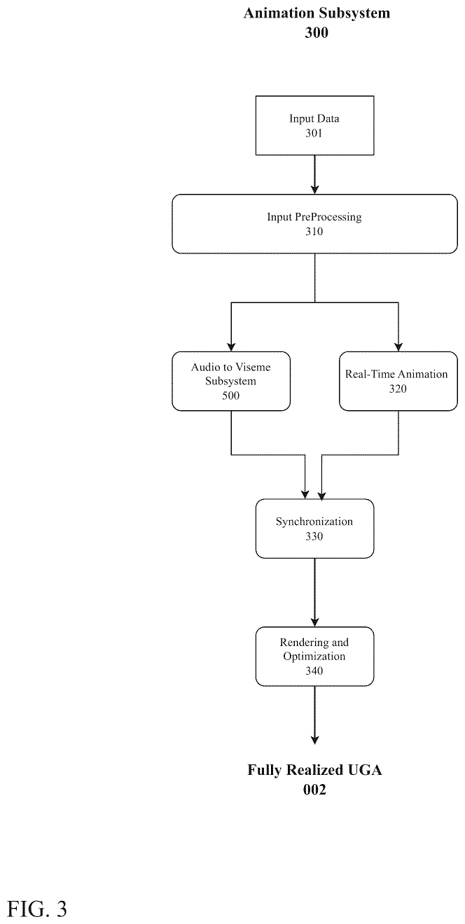

FIG. 3 is a flowchart depicting the animation subsystem 300. The input 301 for the animation subsystem is avatar rigging provided by the asset generation subsystem 200 or an in an embodiment character rigging files generated from third-party animation software or exported to work with game development environments or game engines. This rigging includes the 3D model of the avatar, its skeletal structure, facial rig, and animation controls. The rigging serves as the foundation upon which all animations are built, providing the necessary structure for manipulating the avatar's body and face. Input data 301 is first sent to a preprocessing step 310 where the system detects the file format of the incoming animation data and extracts relevant metadata such as frame rate, duration, and included elements. Following this, the data structure conversion takes place, which involves mapping the skeletal structure of the 3rd party animation to match the system's internal structure, converting blend shapes or morph targets to the system's facial animation format, translating animation curves, and adapting textures and materials to the system's rendering pipeline. The result is sent to the audio to viseme subsystem 500.

Beyond lip-syncing, the audio to viseme subsystem 500 generates a wide range of facial expressions to convey emotions and non-verbal communication. It may use techniques such as blend shape interpolation or muscle simulation to create nuanced and realistic facial movements.

These expressions are informed by both the content of the speech (from the LLM) and the avatar's personality and emotional state (from the personality subsystem).

For body movements, the real-time animation system 320 manipulates the avatar's skeletal rig to produce natural-looking gestures and postures. These movements are closely related to the context of the conversation and the avatar's personality. For example, an enthusiastic avatar might use more expansive gestures, while a shy one might exhibit more restrained movements.

The real-time animation system 320 employs machine learning models trained on motion capture data to ensure that these body movements look natural and human-like. This training data includes a wide variety of human movements, captured from multiple individuals performing various actions, gestures, and expressions. By using motion capture data, the system can learn the nuances of natural human movement, including the subtle variations in timing, acceleration, and coordination that make movements appear lifelike.

This deep learning machine model learns to map high-level movement commands to detailed animation sequences. For example, given an input like “reach for an object,” the model would generate a sequence of joint rotations and positions that mimic how a human would naturally perform this action. The models can account for factors like the avatar's current pose, the target location, and even the emotional state of the character to produce appropriate variations in the movement.

Inverse kinematics (IK) is a key technique used in conjunction with these machine learning models to solve complex movements. IK is a mathematical process that calculates the joint angles needed to place an end effector (like a hand or foot) at a desired position in 3D space. While traditional IK can sometimes produce unnatural poses, the integration of machine learning allows the system to refine these solutions to match more closely with natural human movement patterns.

For example, when the avatar needs to walk, the system doesn't just move the legs in a simplistic pendulum motion. Instead, it uses a combination of learned patterns from motion capture data and IK solutions to create a walk cycle that includes natural weight shifts, arm swings, and subtle body rotations. The machine learning models can adjust these movements based on factors like the avatar's personality (e.g., a confident stride vs. a cautious step) or the environmental context (e.g., walking on a flat surface vs. climbing stairs). Similarly, for a reaching action, the system doesn't just extend the arm in a straight line. It calculates a natural arc of movement, incorporates subtle shifts in the shoulder and torso, and may even adjust the avatar's stance for balance, all based on learned patterns from real human movements.

The use of these techniques allows the Real-Time animation subsystem to manage a wide range of complex movements dynamically and in real-time. Whether the avatar is gesturing during speech, interacting with virtual objects, or simply shifting position, the combination of motion capture-trained machine learning models and inverse kinematics ensures that the movements appear fluid, natural, and contextually appropriate. This approach also allows for greater flexibility and adaptability in the animation system. Rather than relying on a fixed set of pre-animated movements, the system can generate unique, situation-specific animations on the fly, responding to the dynamic nature of user interactions and the evolving conversation context provided by the LLM 600 and personality subsystem 400.

The synchronization step 330 is responsible for aligning multiple aspects of the UGA's performance in real-time. This includes coordinating the generated body movements and gestures with the avatar's speech, facial expressions, and the overall context of the conversation.

The synchronization step employs a timeline management system to keep all these elements in order. This involves tracking the progress of the speech, the current emotional state, ongoing gestures, and any event-based triggers that might influence the animation. Beyond lip-syncing, the synchronization module also ensures that facial expressions and body language are timed correctly with the content of the speech. For example, if the avatar is expressing surprise, the raised eyebrows and widened eyes should occur at the exact moment when the surprising information is being conveyed in the speech.

Another aspect of synchronization is ensuring smooth transitions between different animations. As the conversation progresses and the avatar's emotional state or actions change, the system needs to blend these transitions seamlessly. This might involve interpolating between different animation states or using motion blending techniques to avoid abrupt or unnatural changes in posture or expression.

The resultant data is then passed to the rendering and optimization step 340. Rendering involves taking the animated 3D model of the UGA, complete with its synchronized movements, expressions, and speech, and converting it into 2D images that can be displayed on a screen. This process applies textures, lighting, and potentially other visual effects to create the final visual representation of the UGA.

The real-time nature of the system presents a significant challenge for rendering. Unlike pre-rendered animations, where each frame can be carefully crafted over time, this system needs to produce high-quality visuals on the fly. This requires efficient rendering algorithms and potentially the use of hardware acceleration to meet the demands of real-time interaction.

Optimization is equally crucial to ensure that the system can maintain consistent performance across various devices and network conditions. This involves several strategies, such as dynamically adjusting the complexity of the rendered avatar based on factors like the device's processing power, the avatar's position on screen, or the current network bandwidth. For example, when the avatar is viewed from a distance, a simpler model with fewer polygons might be used, while close-up views would trigger the use of a more detailed model.

Performance monitoring is another important aspect. The system continuously assesses its own performance, looking at metrics like frame rate and latency. If performance starts to degrade, it can trigger various optimization measures to maintain a smooth user experience. Compression and streaming techniques may be employed to reduce the amount of data that needs to be transmitted or processed. This could involve compressing texture data, using efficient animation encoding formats, or streaming in higher-resolution assets only when needed.

The system might also use predictive rendering techniques, where it anticipates likely next frames and precomputes some elements to reduce real-time processing load.

For network-based applications, the rendering and optimization step needs to consider strategies for dealing with varying network conditions. This involves techniques like progressive loading of assets or adaptive quality settings based on available bandwidth.

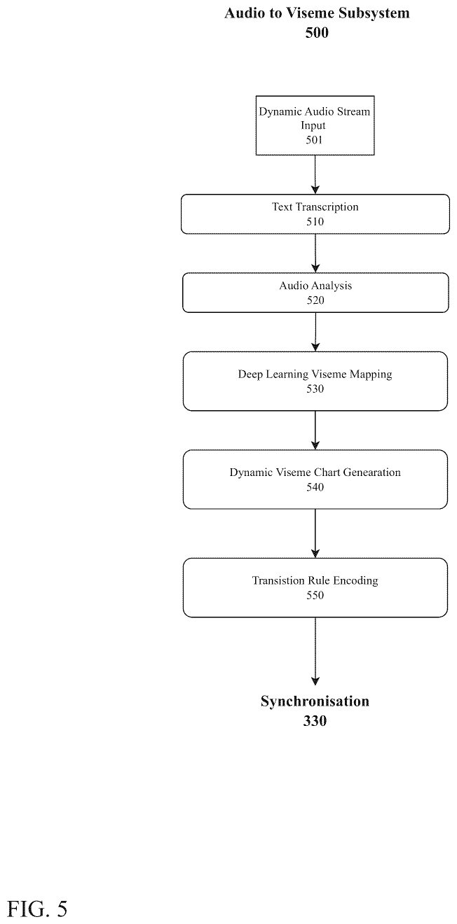

FIG. 5 is a flowchart depicting the Autio to Viseme Subsystem 500 in more detail. The audio to viseme subsystem 500 is designed to achieve realistic lip synchronization for dynamically generated speech. This system automates the traditionally manual process of lip sync animation using advanced machine learning techniques and real-time processing. A key innovation of this system is its ability to create dynamic viseme charts that aren't limited to a fixed number of mappings, unlike traditional methods. This allows for adaptation to different languages, accents, and speech patterns. The system generates animation keyframes synchronized with the audio and determines transition rules for smooth blending between visemes. These rules are dynamically defined, adapting to unique mouth shapes, voice configurations, accents, and emotions, using techniques such as weight ratios, interpolation rules, or spline configurations.

The process begins with a dynamically generated audio stream of human speech 501, which undergoes transcription 510 and subsequently analyzed 520 to detect distinct phonemes. These phonemes are then mapped to appropriate visemes at the deep learning viseme mapping system 530. This recurrent neural network and predictive computing subsystem is trained on large datasets of human speech videos and can be customized for specific languages or actors. It analyzes phoneme sounds and their corresponding mouth shapes, capable of predicting visemes from audio signals in real-time.

The data is then sent to dynamic viseme chart generation 540. Unlike conventional approaches that rely on fixed viseme charts with limited mappings, this system generates viseme charts in real-time as it processes the incoming audio stream. This dynamic approach allows for an unlimited number of phoneme-to-viseme mappings, adapting seamlessly to the intricacies of various languages, accents, and individual speech patterns. The system's ability to capture subtle variations in mouth shapes, which might be lost in a more rigid, pre-defined mapping system, contributes significantly to the naturalness of the resulting animations.

The implementation of the dynamic viseme chart 540 can occur on the client-side in an embodiment, with the viseme mapping created in real-time on the user's device as it receives the audio stream. In another embodiment, the mapping can be generated on a server and transmitted to the client. In another embodiment the viseme map can be encoded directly into the audio stream, with each phoneme-to-viseme mapping included at the precise time sequence or keyframe within the audio data. This flexibility allows the system to adjust on the fly to changes in voice characteristics, emotional states, or even switch between different speakers without interruption.

The data then undergoes transition rule encoding 550. The transition between visemes is crucial for creating natural-looking lip movements, and this system introduces a method of dynamically determining these transition rules in real-time. Unlike traditional animation methods that often rely on predetermined transition rules, this system adapts its rules based on the unique characteristics of each UGA and the specific context of the speech.

These dynamically generated transition rules define how an UGA's lips and facial features transform as the audio speech progresses through different phoneme-to-viseme sound pairings. The rules are not fixed but vary based on several factors, including the unique mouth shapes of different UGA actors, variations in phoneme pronunciation, differences in voice configurations, and the nuances of language, accent, emotion, tonality, and speech pacing. This adaptability allows for a level of realism that is difficult to achieve with more static approaches.

The system represents these transition rules as weight ratios, interpolation rules, or spline configurations, which are then mapped to viseme markings and embedded into a keyframe map synchronized with the audio timeline. This sophisticated approach enables smooth, natural-looking transitions between mouth shapes, avoiding the robotic or unnatural movements that can occur with simpler transition methods. In some implementations, these transition rules are encoded directly into the audio data stream, ensuring perfect synchronization between the audio and visual transitions.

The resultant data is then sent to be synchronized 330 with the real time animation of the UGA in the animation subsystem 300.

The entire process occurs in real-time, with viseme mapping generated as the audio stream is received. This can be processed on either the client-side or server-side, with the viseme map potentially encoded directly in the audio stream or as a separate file. The system's flexibility extends to altering lip shapes independently of audio and adapting to changes in voice characteristics at runtime. It can even handle unexpected scenarios using procedural animation techniques. This dynamic, real-time nature, combined with its unlimited mapping potential and ability to adapt to various speech characteristics on the fly, offers a more flexible and realistic lip-sync solution compared to traditional methods, resulting in a more immersive and interactive experience for the user.

### Personality Subsystem

The personality subsystem is a critical component of the UGA system, designed to dynamically shape the avatar's behavior, speech patterns, and emotional responses. It employs an array of integrated systems and machine learning algorithms to generate and direct various aspects of the UGA's personality in real-time. At its core, the personality subsystem controls the tone, speed, and volume of the UGA's voice, allowing for nuanced representation of character. For example, a confident UGA might speak louder and faster, while a contemplative one might speak more slowly and softly.

Beyond vocal characteristics, the subsystem directs the visualization of unique personality traits through facial expressions, body language, and word choice (in conjunction with the LLM). It ensures consistent representation of these traits across interactions, creating a cohesive and believable character.

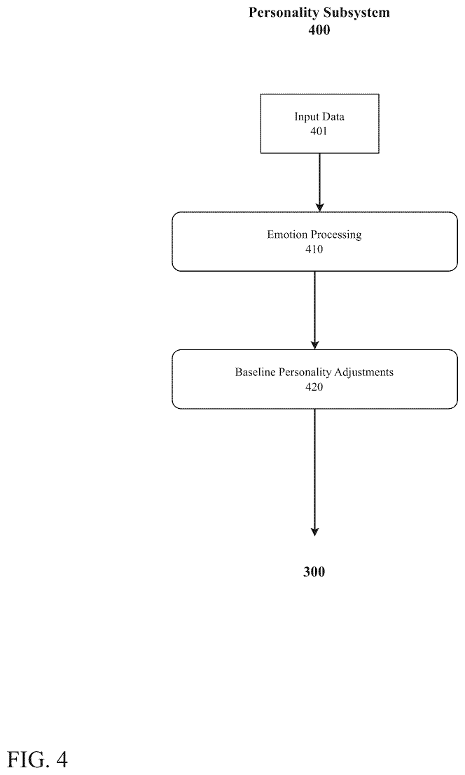

FIG. 4 is a flowchart depicting the personality subsystem 400. Input data 401 from User 101 or the LLM 600 is fed into an emotion processing system 410, where information such as sentiment, intent, and emotional cues is extracted by a natural language processing model. The system's training utilizes supervised machine learning on large datasets of human interactions, including text, audio, and video, labeled with personality traits and emotional states. It incorporates reinforcement learning for adaptation over time and transfer learning for efficient personalization of UGA instances. It may also include supervised machine learning and training on large datasets of human interactions including text conversations, audio recordings, and video footage. These datasets are labeled with personality traits, emotional states, and communication styles. To develop the system's ability to adapt over time, it employs reinforcement learning techniques where the system is rewarded for generating responses that align with desired personality traits and for appropriately adjusting emotional states based on user interactions. The system also uses transfer learning techniques, starting with a base model trained on general personality traits and then fine-tuning for specific UGA instances.

Recurrent neural networks maintain context over long user conversations and model temporal aspects of personality and emotion.

The resulting data is sent to a baseline personality adjustment system 420, where generative models generate new personality traits and emotional responses consistent with the UGA's character. A key feature is the subsystem's ability to evolve the UGA's emotional state over time based on user interactions and conversation context, mirroring human-like personality development.

Upon UGA creation 102, the system generates a baseline personality profile. During interactions, it continuously processes user input and LLM responses, updating the UGA's emotional state across multiple dimensions using probabilistic state estimation. The system adapts the UGA's emotional baseline based on interaction patterns. For instance, consistently positive interactions may lead to a more upbeat personality, while negative ones may result in a more reserved character. The updated personality and emotional state modulate the UGA's responses, including vocal characteristics and visual cues. Over time, the system gradually adjusts baseline personality traits by updating neural network weights or probabilistic model parameters.

The personality subsystem's output drives avatar animations and behaviors, typically including:
1. Emotional State: Multi-dimensional representation of current emotions.
2. Personality Traits: Active traits influencing behavior and expressions.
3. Voice Characteristics: Instructions for voice modulation.
4. Gesture and Expression Cues: Suggestions for appropriate visual responses.

This data is communicated to the animation subsystem 300 via a standardized interface, enabling fluid reflection of personality and emotional state in the avatar's movements and expressions. The subsystem operates in real-time, continuously adjusting the UGA's emotional responses based on immediate conversational context.

Additionally, the personality subsystem generates and directs visualizations and voice representations of the UGA's emotions in response to perceived emotional states of users or other AI characters. It also generates LLM prompts reflecting the UGA's unique personality traits and emotional sensitivities.

### Application Integration Plug-ins and Automation

The invention provides integration methods for a UGA instance to learn about the underlying UI components, data structures, and API calls of a third-party application, allowing the UGA to direct the user experience. This integration can be achieved through SDK and API calls made available to application developers, enabling them to control the UGA's actions and speech based on the application code.

In an embodiment, the UGA can be embedded into a web application's page, where it automatically reads the HTML, Javascript code, and UI components available to the application. As the user instructs the UGA through voice or text commands, the UGA interprets these instructions and interacts with the existing UI components and API calls on behalf of the user.

The invention also provides software tools for application developers to register a list of API calls and data sources, which can be chained together and mapped to “capability” keywords or IDs. These capabilities can be grouped, require authentication, and be assigned to specific UGA instances or all UGAs created by a single developer. The application-specific capabilities can work in conjunction with LLM prompts, embeddings, and tags.

Application capability tags can be embedded within the response text of an LLM and delivered to the UGA in real-time, enabling the UGA to perform app-specific actions in the context of a user's request. These directives can be delivered as part of the encoded audio stream or through a separate message delivered via a message queuing system.

The UGA can interact directly with app-specific images and UI components displayed on the screen by pointing, waving its hands, or running an animation sequence to illustrate “showing” or “invoking” a specific application feature, all in synchronization with the UGA's real-time conversation with the user.

The present invention provides a set of software tools to manage the discrete deployment and versioning of art assets, audio and code files that represent a UGA configuration.

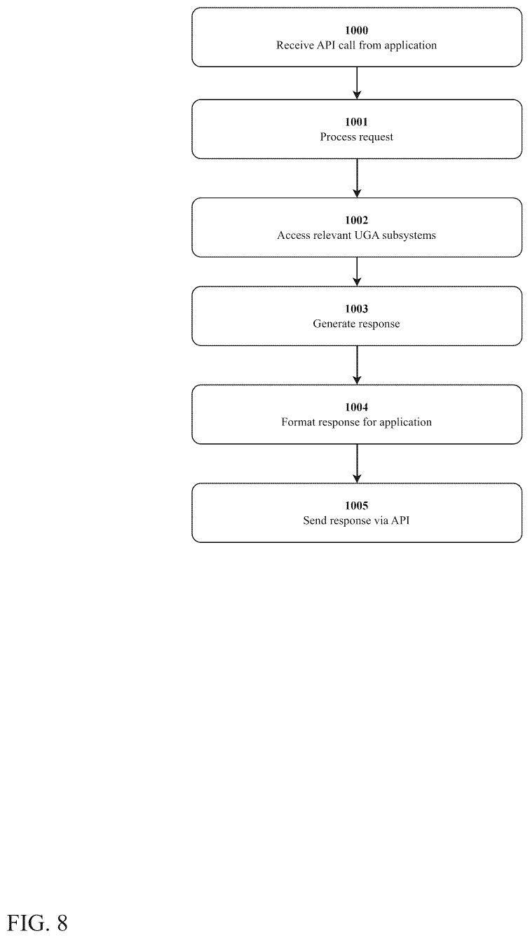

FIG. 8 is a method flowchart depicting the steps for third-party UI integration. The UGA system receives an API call from a third-part application 1000. The UGA system interprets and processes the incoming requests 1001, the accesses the appropriate internal subsystems to generate the required response 1002. The relevant subsystems work independently and together to create a response that fulfills the third-party application's requirements 1003. The generated response is formatted to be compatible with the third-party application's requirements 1004. This formatting may include but is not limited to: data structure, content types, metadata, language tags, security tokens, or compression. The formatted response is sent back to the third-party application through the API 1005.

### UGA Two-Way Messaging System Architecture

The present invention provides a system for subscribing and publishing real-time messages to and from individual or groups of UGA instances. These messages can trigger actions or speech by the UGAs, as configured through software tools, automated API calls, and machine learning subsystems. The architecture allows for unlimited processes and subroutines to be triggered by a query or channel subscription from an individual UGA instance or group of UGA instances. These processes may include converting text to audio, creating phoneme-to-viseme mappings, and archiving responses and audio files. The processes can be linked together as dependent processes or executed asynchronously.

The system also enables UGA instances to interact with each other by subscribing to messages sent by other UGAs. Human users can join these conversations by publishing their audio streams for the UGAs to subscribe to and by subscribing to the audio streams of the UGAs and other users. UGAs can subscribe to various application-specific channels, such as price alerts for flights or personal calendar events and notifications. When relevant information is broadcast on these channels, the UGAs can notify their users accordingly. The invention also allows for broadcast messages to be sent from a server to instruct UGAs to perform certain actions, such as asking idle UGAs to check if their users need assistance or having all UGAs cheer and wish users a happy new year in their configured language at a specific time.

The message-based architecture is a crucial component of the UGA system, enabling real-time dynamic push and pull communications between individual and groups of UGA instances. This distributed messaging system allows UGAs to send and receive structured data packets asynchronously, facilitating the sharing of information, updates on user interactions, and potential collaboration on complex tasks. Each UGA instance is assigned a unique identifier within the system, enabling targeted communication.

The architecture supports both push and pull communications. In push scenarios, UGAs can proactively send updates or information to other UGAs or to a central system. Pull communications allow UGAs to request information from other UGAs or from a central knowledge base. This bidirectional flow of information enables a wide range of use cases, from synchronizing knowledge across UGAs to enabling collaborative problem-solving among multiple expert UGAs.

Integration with the personality subsystem is a key feature of this messaging architecture. UGAs can share updates about their evolving personalities, ensuring that group dynamics among UGAs remain consistent and realistic. Emotional states and recent significant interactions can be communicated, allowing for more nuanced multi-UGA interactions. This integration enhances the system's ability to maintain coherent and engaging user experiences across multiple UGA interactions.

The real-time aspect of the architecture enables truly dynamic interactions. To achieve this, the system employs low-latency communication techniques such as web sockets or server-sent events. Scalability is also a consideration, with the architecture designed to support communication between a large number of UGA instances without significant performance degradation.

Security and privacy are paramount in this messaging system, given the potentially sensitive nature of the information being shared between UGAs. Robust encryption and access control mechanisms are implemented to protect user data and maintain the integrity of UGA interactions. Furthermore, the architecture is designed with extensibility in mind, allowing for easy addition of new message types and communication patterns as the UGA system evolves.

By enabling a network of interconnected, communicating avatars, this message-based architecture significantly enhances the UGA system's capabilities. It allows for more complex, multi-avatar scenarios and improves the system's ability to provide consistent, coordinated, and collaborative interactions across multiple UGAs. This architecture thus plays a vital role in creating a more dynamic, responsive, and interconnected UGA ecosystem.

### Reporting and Analytics

The present invention provides a set of software tools that tracks, analyzes, and displays the usage of an UGA configuration and each of its discrete components in a live deployment environment.

The claimed invention offers a comprehensive system that tracks and analyzes the types of questions posed to the UGA, as well as the application specific tasks it can perform. This system generates detailed reports that visualize statistics on the number of successfully answered questions and the completion of app-specific tasks by the UGA. The metrics tracked include the number of sessions, unique users, average sessions per user, queries per session, total queries per UGA instance, and the average duration of a session. Additionally, the system monitors the number of application tasks completed, the number of successful tasks completed, average response times, and the average length of responses. By providing these insights, the invention enables users to gain a deeper understanding of the UGA's performance and effectiveness in handling user inquiries and executing application-specific functions.

In one embodiment, the system can provide analytics on the number of times the UGA was shown within an application and the average duration in which users interacted with the UGA over the course of a set time frame.

### Authorization and Licensing

The present invention provides a set of software tools and data processing routines that authorizes the hosting and use of an UGA configuration and each of its discrete components in a live deployment environment. When an UGA instance is created, the present invention provides a method for creating a unique hashed authentication token that identifies the UGA instance and is included with an embeddable widget code that is used by the application developer to place the UGA within a web application.

When the UGA is loaded from an application's server, the auth token is passed to the Sagen authentication server which verifies that the UGA request is valid and authorized to run on the specific domain that the request originated from.

The present invention also provides a method of tracking the usage of specific features and capabilities of the UGA and corresponding these usage stats to a payment method, software subscription plan, and billing system. Certain features may be disabled or enabled for a specific UGA instance based upon the subscription plan and billing status of a specified UGA instance.

### Watermarking and Uniqueness

The claimed invention provides a system for recreating the likeness of a well-known public figure (actor, singer, celebrity, etc.) and creating the public figure as an UGA. In this case, the public figure may want to limit the number of times the UGA may be used and prevent an UGA instance from being digitally copied or installed on unauthorized websites or applications.

The claimed invention provides a method of limiting the number of instances created by a specific UGA configuration and watermarking each instance.

In one embodiment the instance's watermark is represented as a unique hashed code on a blockchain whereby a public figure maintains ownership of each unique instance and the present invention keeps track of and monitors activity of potential counterfeits on behalf of the public figure.

In a variation of an embodiment, the present invention embeds the unique identity of an UGA instance into the blockchain and each interaction with the UGA is recorded on the blockchain which further defines its uniqueness.

### Exemplary Computing Environment

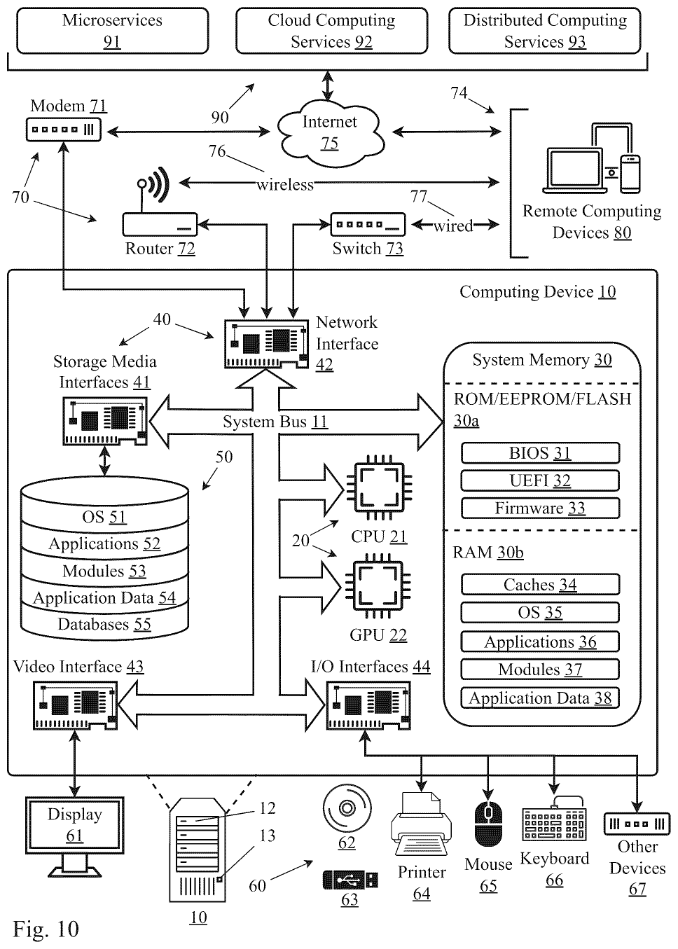

FIG. 10 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA

(EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM) and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically usc RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid-state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCle. SATA is the traditional interface for HDDs and SATA SSDs, while NVMe (Non-Volatile Memory Express) is a newer, high-performance protocol designed for SSDs connected via PCle. PCle SSDs offer the highest performance due to the direct connection to the PCle bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for generating interactive avatar-based conversational experiences, comprising:
a computing device comprising at least a memory and a processor;
a plurality of programming instructions that, when operating on the processor, cause the computing device to:
implement an avatar creation tool allowing users to generate unique avatars using a user interface system which interacts with machine learning subsystems to direct avatar creation to the user's specifications;
employ one or more avatar animation machine learning subsystems configured to automatically generate avatar speech, body movements, gestures, and emotional responses in real-time based on the context of a conversation with a user;
operate one or more avatar personality machine learning subsystems configured to direct the avatar's voice, personality traits, and emotional responses based on the context of the conversation and the perceived emotional state of the user;
execute a lip-sync animation subsystem configured to map phonetic voice patterns to viseme mouth shapes in real-time, including dynamic viseme chart generation and transition rule encoding; and
integrate one or more large language models (LLMs) configured to generate contextually relevant and emotionally responsive conversations.

2. The system of claim 1, further comprising the utilization of one or more avatar asset generator machine learning subsystems configured to create unique avatar configurations by allowing users or clients to upload photographs or videos of a human persona or illustrated character.

3. The system of claim 1, further comprising the management of a blockchain-based system for avatar instance management and usage tracking.

4. The system of claim 1, further comprising the implementation of a reporting and analytics module for tracking and analyzing avatar usage and performance.

5. The system of claim 1, further comprising the implementation of an authorization and licensing module using hashed authentication tokens for secure avatar deployment.

6. The system of claim 1, further comprising an integration subsystem configured to enable the avatar to interact with user interface elements and data structures of a third-party application.

7. The system of claim 1, further comprising a deployment and asset management subsystem configured to track usage of avatar configurations and their individual components in live deployments.

8. The system of claim 1, further comprising a two-way messaging architecture configured to enable real-time interactions between avatars and users.

9. The system of claim 1, wherein the avatar personality machine learning subsystems are configured to dynamically evolve the avatar's personality based on user interactions over time.

10. The system of claim 1, further comprising a watermarking system for limiting and tracking instances of avatar configurations, including blockchain-based unique identifiers.

11. A method for creating interactive avatar-based conversational experiences, comprising:
generating unique avatars using an Avatar Creation Tool with a user interface system that interacts with machine learning subsystems to direct avatar creation to user specifications;
animating the avatar in real-time using one or more avatar animation machine learning subsystems based on the context of a conversation with a user;
directing the avatar's voice, personality traits, and emotional responses using one or more avatar personality machine learning subsystems based on the context of the conversation and the perceived emotional state of the user;
mapping phonetic voice patterns to viseme mouth shapes for lip-sync animation in real-time, including dynamic viseme chart generation and transition rule encoding; and
generating contextually relevant and emotionally responsive conversations using one or more large language models (LLMs).

12. The method of claim 11, further comprising the utilization of one or more avatar asset generator machine learning subsystems configured to create unique avatar configurations by allowing users or clients to upload photographs or videos of a human persona or illustrated character.

13. The method of claim 11, further comprising the management of a blockchain-based system for avatar instance management and usage tracking.

14. The method of claim 11, further comprising the implementation of a reporting and analytics module for tracking and analyzing avatar usage and performance.

15. The method of claim 11, further comprising the implementation of an authorization and licensing module using hashed authentication tokens for secure avatar deployment.

16. The method of claim 7, further comprising integrating the avatar with a third-party application to enable interaction with user interaction elements and data structures.

17. The method of claim 7, further comprising tracking usage of avatar configurations and their individual components using a deployment and asset management subsystem.

18. The method of claim 7, further comprising enabling real-time interactions between avatars and users through a two-way messaging architecture.

19. The method of claim 7, wherein the avatar's personality dynamically evolves based on user interactions over time.

20. The method of claim 7, further comprising watermarking and tracking instances of avatar configurations using blockchain-based unique identifiers.
